(19) United States
(12) Patent Application Publication
(10) Pub. No.: US 2026/0364771 A1
(43) Pub. Date: Nov. 19, 2026

(54) TOOL POSITIONING TRAY AND MANUFACTURING METHOD OF THE SAME

(71) Applicant: Ming Fan Liu, Taichung City (TW)

(72) Inventor: Ming Fan Liu, Taichung City (TW)

(21) Appl. No.: 19/672,794

(22) Filed: May 11, 2026

(30) Foreign Application Priority Data
May 14, 2025 (TW) 114118080

(51) Int. Cl. B25H 3/06; B29C 51/10; B29C 51/14; B29L 31/00

(52) U.S. Cl. CPC B25H 3/06; B29C 51/10; B29C 51/14; B29L 2031/712

(57) ABSTRACT

A tool positioning tray has a tray body having a base layer and a first foam layer laminated onto a top of the base layer. The tray body is subjected to a vacuum forming process to form at least one positioning cavity recessed in a top of the tray body. The tool positioning tray and manufacturing method of the same provide good structural support while also offering cushioning performance, refined visual aesthetics, a lightweight design, and cost-effectiveness.

### BACKGROUND OF THE INVENTION

### 1. Field of the Invention

The present invention relates to a tool positioning tray for accommodating tools, and more particularly to a tool positioning tray providing cushioning performance with good structural support.

### 2. Description of Related Art

A tool positioning tray is an inert within a tool box for accommodating tools. The tool positioning tray mainly includes multiple positioning cavities to accommodate various tools, respectively, thereby allowing the tools to be securely stored within the tool box without shifting. Conventional tool positioning trays are categorized into blister positioning trays and foam positioning pads.

The blister positioning tray is typically manufactured from a thin plastic sheet, e.g., Polyvinyl Chloride (PVC) sheet, Polystyrene (PS) sheet, Polypropylene (PP) sheet, or Polyethylene Terephthalate (PET) sheet, which is subjected to a vacuum forming process to form multiple concave positioning cavities for accommodating tools therein. The blister positioning tray provides good structural support with a light weight housing and low cost. However, the blister positioning tray has poor cushioning performance, is visually unrefined, and lacks aesthetic appeal.

The foam positioning pad is typically made by cutting a foam substrate into multiple positioning cavities. Leveraging cushioning performance of the foam substrate, the tools are securely accommodated within the foam positioning pad to provide optimal organization and protection. The foam positioning pad has good shock absorption and refined visual aesthetics. However, the foam positioning pad is prone to deformation, lacks structural support, and is bulky and expensive.

Consequently, the conventional tool positioning tray cannot provide good structural support while also offering cushioning performance, refined visual aesthetics, a lightweight design, and cost-effectiveness.

To overcome the shortcomings, the present invention provides a tool positioning tray and manufacturing method of the same to mitigate or obviate the aforementioned problems.

### SUMMARY OF THE INVENTION

The main objective of the present invention is to provide a tool positioning tray and a manufacturing method of the same, wherein the tool positioning tray may provide good structural support while offering cushioning performance, refined visual aesthetics, a lightweight design, and cost-effectiveness.

The tool positioning tray in accordance with the present invention comprises a tray body comprising a base layer and a first foam layer laminated onto a top of the base layer. The tray body is subjected to a vacuum forming process to form at least one positioning cavity recessed in a top of the tray body.

The manufacturing method of a tool positioning tray in accordance with the present invention comprises steps of forming a tray body in sheet form comprising a base layer and a first foam layer laminated onto a top of the base layer; placing the tray body into a vacuum forming device; subjecting the tray body to a vacuum forming process to form at least one positioning cavity recessed in a top of the tray body.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a first embodiment of a tray body in sheet form in accordance with the present invention;

FIG. 2 is an enlarged cross-sectional view of the tray body in FIG. 1;

FIG. 3 is a schematic view of placing the tray body in FIG. 1 into a vacuum forming device;

FIGS. 4 and 5 are schematic views of forming at least one positioning cavity recessed in the tray body in FIG. 1;

FIG. 6 is a top view of the first embodiment of a tool positioning tray in accordance with the present invention;

FIG. 7 is an enlarged cross-sectional view of the tool positioning tray in FIG. 6; and

FIG. 8 is an enlarged cross-sectional view of a second embodiment of a tool positioning tray in accordance with the present invention.

### DETAILED DESCRIPTION OF THE PREFERRED EMBODIMENTS

In a first embodiment, a manufacturing method of a tool positioning tray in accordance with the present invention comprises steps as follows.

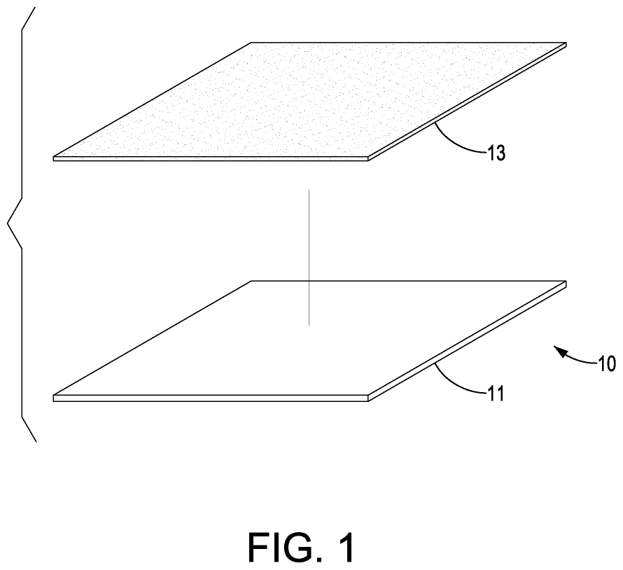

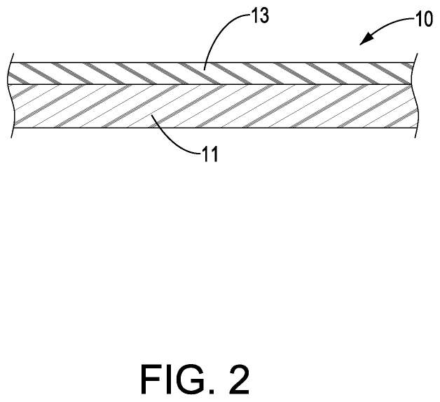

FIGS. 1 and 2 show a step for forming a tray body 10 in sheet form. The tray body 10 comprises a base layer 11 and a first foam layer 13 laminated onto a top of the base layer 11. The base layer 11 is made of a plastic material, such as a plastic sheet, e.g., PVC sheet, PS sheet, PP sheet, or PET sheet. The first foam layer 13 is made of a foam material, such as ethylene vinyl acetate (EVA) or Polyurethane (PU) foam. The first foam layer 13 may be laminated onto the top of the base layer 11 via an adhesive or other means.

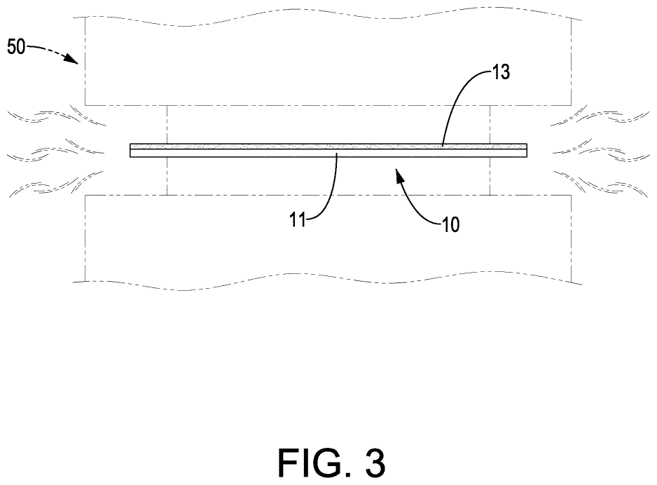

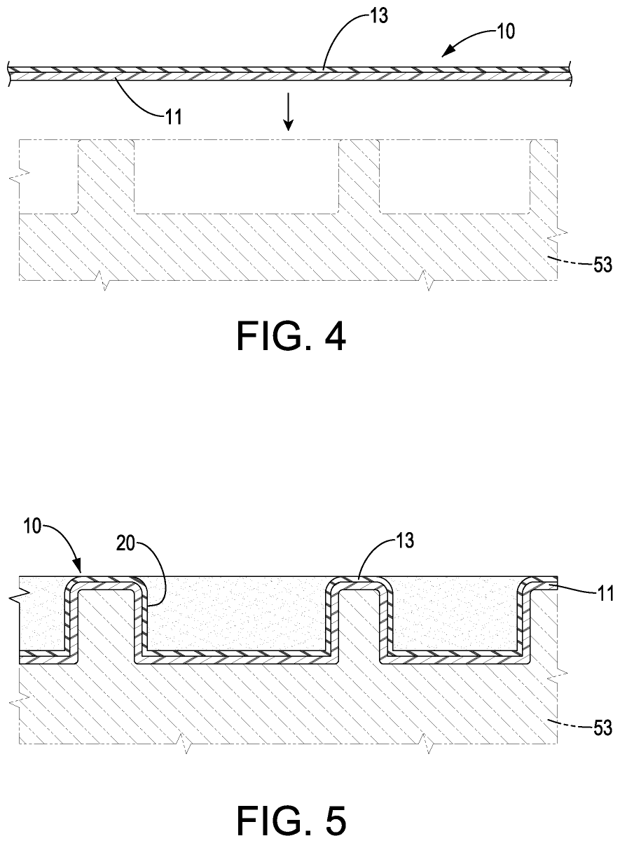

FIGS. 3 to 5 show a step of placing the tray body 10 in sheet form into a vacuum forming device 50, and a step of subjecting the tray body 10 in sheet form to a vacuum forming process to form at least one positioning cavity 20 recessed in a top of the tray body 10. Wherein, the vacuum forming device 50 mainly comprises a forming mold 53. The vacuum forming process comprises acts of softening the tray body 10 by heating, moving the forming mold 53 relatively toward the tray body 10, exhausting air between the tray body 10 and the forming mold 53 for conforming the tray body 10 snugly to the forming mold 53 to form the at least one positioning cavity 20 recessed in the top of the tray body 10, and then, moving the forming mold 53 relatively away from the tray body 10. After cooling, the tray body 10 is removed from the vacuum forming device 50.

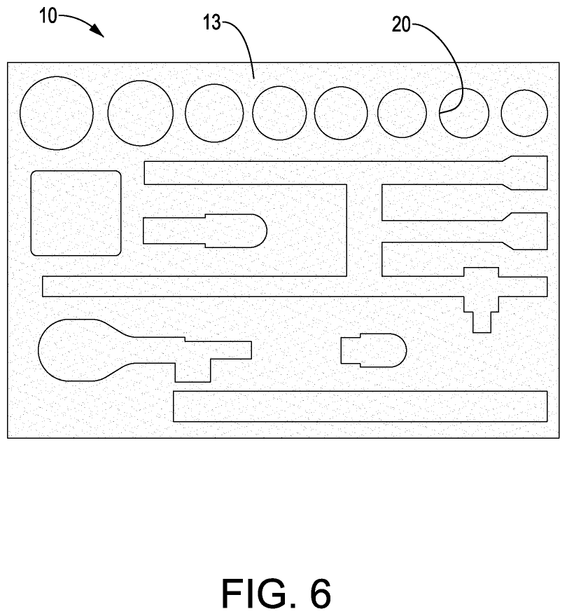

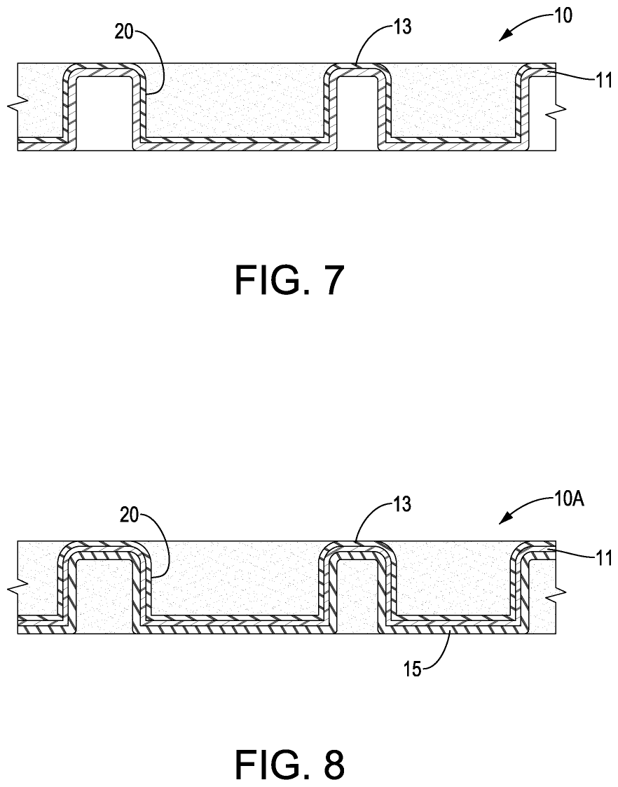

With reference to FIGS. 6 and 7, the tool positioning tray comprises the tray body 10 and the at least one positioning cavity 20 recessed in the top of the tray body 10. Wherein, the tray body 10 comprises the base layer 11 and the first foam layer 13 laminated onto the top of the base layer 11. The tray body 10 is subjected to a vacuum forming process to form the at least one positioning cavity 20 recessed in the top of the tray body 10.

Since the tray body 10 comprises the base layer 11 and the first foam layer 13 at the top of the base layer 11, the first foam layer 13 is adapted to contact tools and provide cushioning resilience, to protect the tools from impact and damage. The base layer 11 provides under-support to the first foam layer 13, to maintain a shape of the tray body 10, to prevent the at least one positioning cavity 20 at the top of the tray body 10 from deformation, and to provide good structural support. Whereby, the tool positioning tray may provide good structural support with cushioning performance at the same time.

The tool positioning tray in accordance with the present invention is manufactured by subjecting a sheet-like tray body 10 to a vacuum forming process to form the at least one positioning cavity 20. Compared to a conventional foam positioning pad, the tool positioning tray in accordance with the present invention is slimmer and lighter, is difficult to deform, provides good structural support, and has low manufacturing costs. Compared to a conventional blister positioning tray, the tool positioning tray in accordance with the present invention provides good cushioning resilience by the first foam layer 13 to stably and securely accommodate tools with a refined visual surface.

With reference to FIG. 8, in a second embodiment of the tool positioning tray in accordance with the present invention, the tray body 10A comprises a said base layer 11, a said first foam layer 13 laminated onto the top of the base layer 11, and a second foam layer 15 laminated onto a bottom of the base layer11. The second foam layer 15 is made of a foam material. The tray body 10A is subjected to a vacuum forming process to form the at least one positioning cavity 20 recessed in the top of the tray body 10A.

Since the second foam layer 15 is laminated onto the bottom of the base layer 11, an exposed area of the base layer 11 is reduced. The tray body 10A is visually presented as an all-foam surface with refined visual aesthetic.

The tool positioning tray and manufacturing method of the same in accordance with the present invention may provide good structural support while also offering cushioning performance, refined visual aesthetics, a lightweight design, and cost-effectiveness.

What is claimed is:

1. A tool positioning tray comprising
a tray body comprising a base layer and a first foam layer laminated onto a top of the base layer; and
the tray body subjected to a vacuum forming process to form at least one positioning cavity recessed in a top of the tray body.

2. The tool positioning tray as claimed in claim 1, wherein the base layer is a plastic sheet and the first foam layer is made of a foam material.

3. The tool positioning tray as claimed in claim 2, wherein the tray body comprises a second foam layer laminated onto a bottom of the base layer.

4. The tool positioning tray as claimed in claim 3, wherein the second foam layer is made of a foam material.

5. A manufacturing method of a tool positioning tray comprising steps of:
forming a tray body in sheet form comprising a base layer and a first foam layer laminated onto a top of the base layer;
placing the tray body in sheet form into a vacuum forming device;
subjecting the tray body in sheet form to a vacuum forming process to form at least one positioning cavity recessed in a top of the tray body.

6. The manufacturing method of the tool positioning tray as claimed in claim 5, wherein the base layer is a plastic sheet and the first foam layer is made of a foam material.

7. The manufacturing method of the tool positioning tray as claimed in claim 6, wherein the vacuum forming process comprises acts of:
softening the tray body by heating;
moving a forming mold of the vacuum forming device relatively toward the tray body;
exhausting air between the tray body and the forming mold for conforming the tray body snugly to the forming mold to form the at least one positioning cavity recessed in the top of the tray body; and
moving the forming mold of the vacuum forming device relatively away from the tray body.

8. The manufacturing method of the tool positioning tray as claimed in claim 5, wherein the tray body comprises a second foam layer laminated onto a bottom of the base layer.

9. The manufacturing method of the tool positioning tray as claimed in claim 6, wherein the tray body comprises a second foam layer laminated onto a bottom of the base layer.

10. The manufacturing method of the tool positioning tray as claimed in claim 7, wherein the tray body comprises a second foam layer laminated onto a bottom of the base layer.

11. The manufacturing method of the tool positioning tray as claimed in claim 8, wherein the second foam layer is made of a foam material.

12. The manufacturing method of the tool positioning tray as claimed in claim 9, wherein the second foam layer is made of a foam material.

13. The manufacturing method of the tool positioning tray as claimed in claim 10, wherein the second foam layer is made of a foam material.
